(19) United States
(12) Patent Application Publication
(10) Pub. No.: US 2024/0272628 A1
(43) Pub. Date: Aug. 15, 2024

(54) WORK MANAGEMENT SYSTEM

(71) Applicant: Honda Motor Co., Ltd., Tokyo (JP)

(72) Inventors: Ryo KOJIMA, Tokyo (JP); Taisuke MORIMOTO, Tokyo (JP); Ginga KITASE, Tokyo (JP); Mei FUJIMOTO, Tokyo (JP); Ryota NAKANISHI, Tokyo (JP); Yuki ARAI, Tokyo (JP)

(73) Assignee: Honda Motor Co., Ltd., Tokyo (JP)

(21) Appl. No.: 18/434,783

(22) Filed: Feb. 6, 2024

(30) Foreign Application Priority Data
Feb. 10, 2023 (CN) 202310097918.1

(51) Int. Cl. G05B 19/418

(52) U.S. Cl. CPC G05B 19/4187

(57) ABSTRACT

Provided is a work management system. The work management system manages an operating status of a tool of a worker and includes: a target object arranged on a tool; and a sensor capable of detecting the target object. The target object is movable such that it faces the sensor.

### CROSS-REFERENCE TO RELATED APPLICATION

This application claims the priority benefit of China application serial no. 202310097918.1, filed on Feb. 10, 2023. The entirety of the above-mentioned patent application is hereby incorporated by reference herein and made a part of this specification.

### BACKGROUND

### Technical Field

The disclosure relates to a management system, and in particular to a work management system that manages an operating status of a tool of a worker.

### Related Art

In recent years, research and development on work management systems that contribute to energy efficiency have been ongoing in order to ensure access to affordable, reliable, sustainable, and advanced energy for more people.

In the prior art, a technical solution has been disclosed that uses a global positioning system (GPS) to detect the position of a tool (such as a nut wrench) managed by a work management system.

However, when GPS is used to detect the position of a tool, problems with decreased accuracy caused by the presence of obstacles and communication carrier failures may occur.

The disclosure improves work efficiency while also avoiding decrease in accuracy caused by the presence of obstacles and communication carrier failures. Furthermore, it contributes to energy efficiency.

### SUMMARY

The disclosure provides a work management system for managing an operating status of a tool of a worker. The work management system includes: a target object arranged on the tool; and a sensor capable of detecting the target object. The target object is movable such that it faces the sensor.

### BRIEF DESCRIPTION OF THE DRAWINGS

The accompanying drawings are included to provide a further understanding of the disclosure, and are incorporated in and constitute a part of the disclosure. The drawings illustrate embodiments of the disclosure and, together with the description, serve to explain the principles of the disclosure.

FIG. 1 shows a schematic block diagram of a work management system according to an embodiment of the disclosure.

FIGS. 2A to 2E show examples of a target object according to an embodiment of the disclosure.

FIGS. 3A to 3D show examples of a target object according to another embodiment of the disclosure.

FIGS. 4A and 4B show a step flow chart of a work management method according to an embodiment of the disclosure.

### DESCRIPTION OF THE EMBODIMENTS

In an embodiment of the disclosure, the work management system further includes: a management device for managing the operating status of the tool. The tool is provided with a transmission unit, and the transmission unit transmits operation information of the tool of the worker and orientation information of the target object when the tool is operated to the management device.

In an embodiment of the disclosure, the target object is rotatably arranged along an axial line extending horizontally relative to the tool, and a movable counterweight is provided such that the target object faces the sensor by gravity.

In an embodiment of the disclosure, the target object is provided on an upper surface of a liquid level, so as to be detectable by the sensor facing downward.

Based on the above, the work management system of the disclosure may provide a tool with a movable target object, and maintain the direction of the target object to face the sensor arranged in the facility (in the factory or on the equipment). As a result, the sensor's detection accuracy for the target object will not be reduced (the target object cannot be detected correctly) because the direction of the tool changes during use. This allows the tool to change direction freely as the work progresses, which not only improves work efficiency but also contributes to energy efficiency. Moreover, unlike the situation where GPS is used for coordinate measurement, the disclosure can also avoid the decrease in accuracy caused by the presence of obstacles and communication carrier failures.

In order to make the above-mentioned features and advantages of the disclosure more obvious and understandable, the following embodiments are specifically described in detail with reference to the accompanying drawings.

Reference will now be made in detail to the exemplary embodiments of the disclosure, examples of which are illustrated in the accompanying drawings. Whenever possible, the same reference numbers are used in the drawings and description to refer to the same or similar parts.

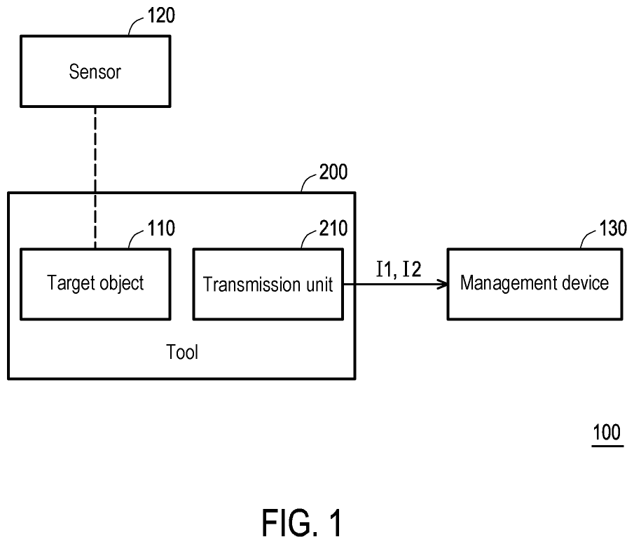

FIG. 1 shows a schematic block diagram of a work management system according to an embodiment of the disclosure. Referring to FIG. 1, a work management system 100 is used to manage the operating status of a tool 200 of the worker. In this embodiment, the tool 200 is, for example, a hand tool such as a nut wrench. Specifically, when the worker mounts parts using hand tools, the work management system 100 may use non-contact three-dimensional coordinate measurement technology to link the output value (such as torque value, etc.) of the hand tool used by the worker during the work process with the work coordinates of the hand tool, which can reduce many steps in work confirmation and ensure work quality in the upstream process.

The work management system 100 includes a target object 110, a sensor 120, and a management device 130. The target object 110 is, for example, a tag capable of communicating with the sensor 120 in a non-contact manner and be detected by the sensor 120. As shown in FIG. 1, the target object 110 is arranged on the tool 200.

The sensor 120 is capable of detecting the target object 110 to obtain the coordinate information of the target object 110. The sensor 120 includes, for example, an image sensor and a distance sensor. The image sensor may, for example, detect the XY coordinates of the target object 110. The distance sensor may, for example, detect the Z coordinate of the target object 110. In practical applications, the sensor 120 may be, for example, one or more cameras, three-dimensional cameras, radar (Radio Detection and Ranging), lidar (Light Detection and Ranging) or other similar devices or a combination of the above devices.

The management device 130 is, for example, an electronic device such as a personal computer, a notebook computer, a server computer, a tablet computer, a workstation, etc., and may be used to manage the operating status of the tool 200. On the tool 200A, a transmission unit 210. The transmission unit 210 may transmit operation information I1 of the tool 200 of the worker and orientation information I2 of the target object 110 when the tool 200 is operated to the management device 130. The transmission unit 210 may be, for example, an infrared light-emitting component capable of transmitting wireless signals (infrared signals) to the management device 130 to send information, but the disclosure is not limited thereto. In other embodiments, the transmission unit 210 may also use various wireless communication standards such as Bluetooth Communication Protocol, WiFi (Wireless Fidelity) Communication Protocol, and WiFi Direct to perform wireless signal transmission with the management device 130.

When the target object 110 is detected by the sensor 120 mounted above the target object 110 (e.g., on the ceiling), since the target recognition angle has its range limit, if the angle between a vertical line perpendicular to a surface (e.g., detection surface of the tag) detected by the sensor 120 on the target object 110 and an axial line extending vertically downward from the sensor 120 is too large (e.g., more than 45 degrees), it may occur that the sensor 120 is unable to correctly recognize the target object 110. Thus, in this embodiment, the target object 110 is movable such that it faces the sensor 120. That is, no matter how the direction of the tool 200 changes, the target object 110 of the embodiment is able to maintain the direction of the target object 110 to face the sensor 120 at all times through its own movement or rotation. In this way, the vertical line perpendicular to the detection surface of the target object 110 and the axial line extending vertically downward from the sensor 120 may be kept as parallel as possible. This allow the tool 200 to change direction freely as the work progresses, which not only improves work efficiency, but also contributes to energy efficiency.

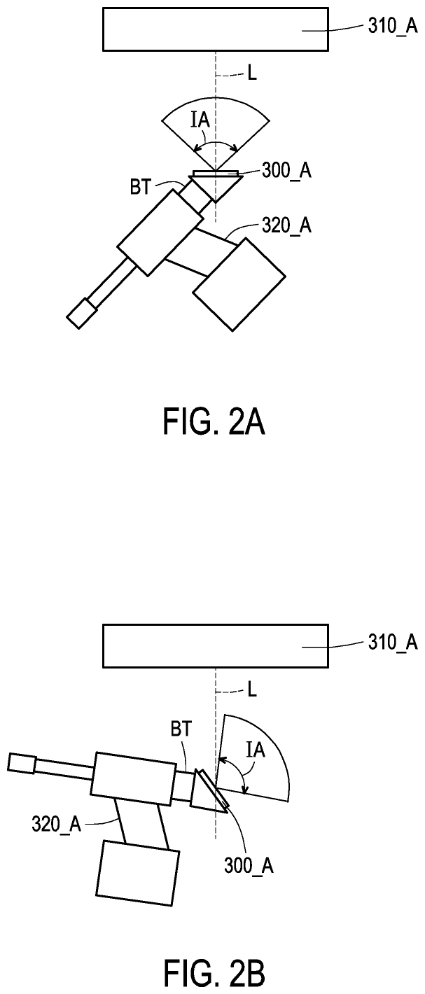

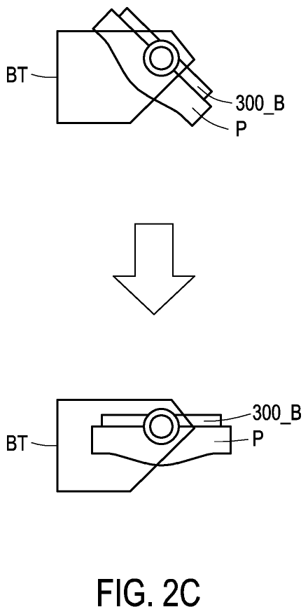

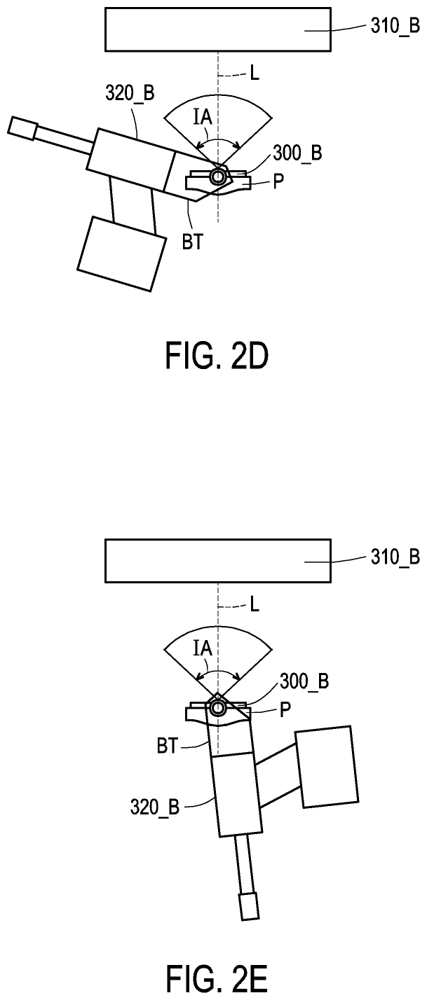

The following examples are given to illustrate embodiments of the target object. FIGS. 2A to 2E show examples of a target object according to an embodiment of the disclosure. FIG. 2A shows a target recognition angle IA of a sensor 310_A mounted above a target object 300_A (e.g., on the ceiling) for the target object 300_A arranged on a tool 320_A. In FIG. 2A, the tool 320_A is a nut wrench, and the target object 300_A is fixedly arranged on a bracket BT at an end of the tool 320_A. In this embodiment, the range of the target recognition angle IA will be spread 90 degrees (45 degrees front to back) on the detection surface of the target object 300_A centered on a vertical line perpendicular to the detection surface of the target object 300_A. As shown in FIG. 2A, when the detection surface of the target object 300_A is made to face upwardly toward the sensor 310_A along with a posture of the tool 320_A, an axial line L extending vertically downward from the sensor 310_A and passing through the detection surface of the target object 300_A will be located within the range of the target recognition angle IA. At this time, the sensor 310_A is able to correctly recognize the target object 300_A so as to successfully obtain relevant information of the target object 300_A.

However, since the target object 300_A is fixedly arranged on the tool 320_A, whenever the posture of the tool 320_A is changed, the axial line L extending downward from the sensor 310_A may be out of the range of the target recognition angle IA such that the sensor 310_A is unable to correctly recognize the target object 300_A. For example, as shown in FIG. 2B, when work is performed on a workpiece that is perpendicular to the ground through the tool 320_A, the tool 320_A shifts to a slightly horizontal posture, such that the axial line L extending downward from the sensor 310_A is not located within the range of the target recognition angle IA. In this case, the sensor 310_A is unable to correctly recognize the target object 300_A (e.g., there are problems such as coordinate deviation and shake during the recognition).

Thus, in the embodiment of the disclosure, as shown in FIG. 2C, a rotation axis is arranged on the bracket BT of a tool 320_B, and a target object 300_B arranged on a mounting plate P of the bracket BT is rotatably arranged along an axial line extending horizontally relative to the bracket BT. Moreover, the center of gravity of the mounting plate P is placed below the center of rotation through the design of the shape (heavy object may also be used), and a movable counterweight is arranged such that the target object 300_B faces a sensor 310_B by gravity.

In this way, the target object 300_B is able to maintain the direction of the target object 300_B to face the sensor 310_B at all times through its own rotation. As shown in FIG. 2D, when work is performed on the workpiece that is perpendicular to the ground through the tool 320_B, even though the tool 320_B shifts to a slightly horizontal posture, the direction of the target object 300_B may be maintained to face the sensor 310_B at all times, and the axial line L extending downward from the sensor 310_A will be kept within the range of the target recognition angle IA. As a result, the sensor 310_B is able to correctly recognize the target object 300_B so as to successfully obtain relevant information of the target object 300_B.

Similarly, as shown in FIG. 2E, when work is performed on a workpiece that is horizontal to the ground through the tool 320_B, although the tool 320_B changes to a slightly vertical posture, the direction of the target object 300_B may still be maintained to face the sensor 310_B at all times, and the axial line L extending downward from the sensor 310_B will be kept with the range of the target recognition angle IA. Thus, even if the posture of the tool 320_B changes, the sensor 310_B is still able to correctly recognize the target object 300_B so as to successfully obtain relevant information of the target object 300_B.

It should be noted that although the sensor 310_B in this embodiment is mounted above the target object 300_B (e.g. on the ceiling), the disclosure is not limited thereto. People having ordinary skill in the art may change the shape of the counterweight of the mounting plate P such that the target object 300_B is maintained to face the sensor 310_B arranged in various directions at all times.

Through the above example, it is possible to improve the unrecognized range in the tool usage postures and realize non-contact three-dimensional coordinate measurement by simply mounting one target object.

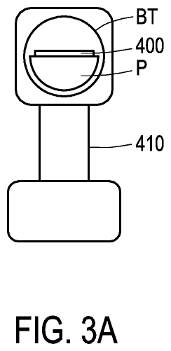

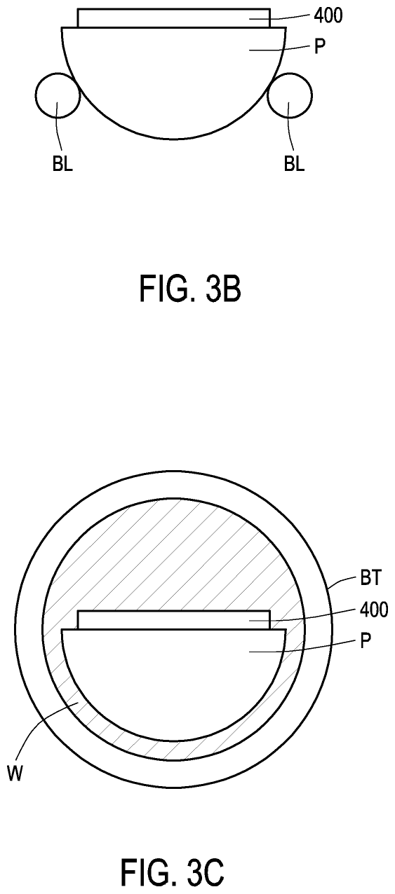

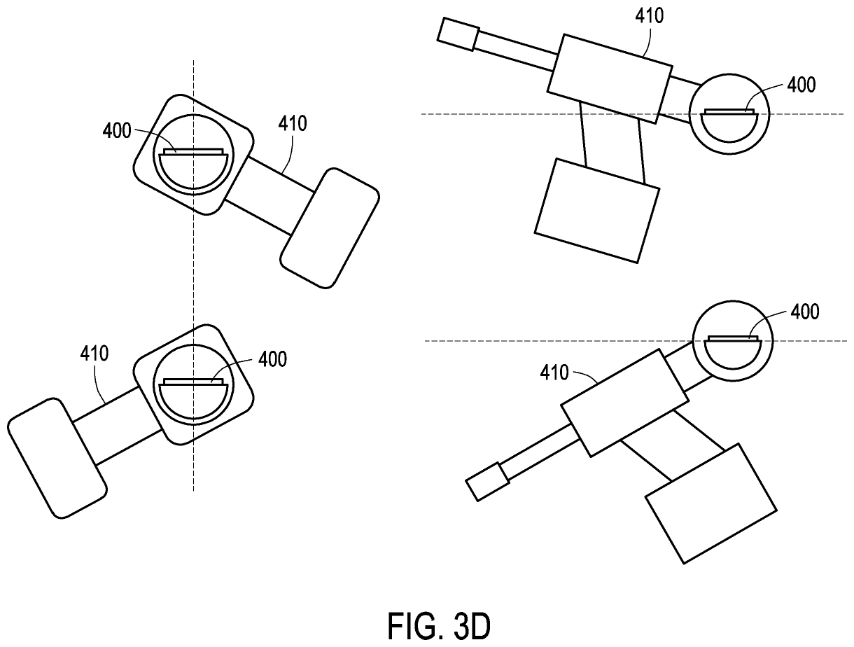

FIGS. 3A to 3D show examples of a target object according to another embodiment of the disclosure. In FIG. 3A, the mounting plate P used to mount a target object 400 in the bracket BT is designed to be hemispherical. As shown in FIG. 3B, for example, a plurality of balls BL may be used to support the mounting plate P within the bracket BT. By supporting the mounting plate P by rolling the balls BL, the posture of the target object 400 may be rotated along three axes extending in the X direction, the Y direction, and the Z direction, and due to the action of gravity, the direction (detection surface) of the target object 400 is maintained to face the sensor mounted above the target object 400 (for example, on the ceiling) at all times (the posture of the target object 400 remains horizontal to the sensor).

Moreover, in FIG. 3C, the material of the bracket BT is, for example, a transparent material such as glass, and the target object 400 mounted on the hemispherical mounting plate P is sealed together with lubricant W (such as water, etc.) in the sealed space inside the bracket BT. With the help of the lubricant W, the posture of the target object 400 may be rotated along three axes extending in the X direction, the Y direction, and the Z direction, and due to the action of gravity, the direction (detection surface) of the target object 400 is maintained to face the sensor mounted above the target object 400 at all times (the posture of the target object 400 remains horizontal to the sensor). In an embodiment, in the sealed space inside the bracket BT, the target object 400 may also be provided on an upper surface of a liquid level of the lubricant W, so as to be detectable by a sensor facing downward.

In this way, the target object 400 is able to maintain the direction of the target object 400 to face the sensor at all times by its own rotation along three axes extending in the X direction, the Y direction, and the Z direction. As shown in FIG. 3D, no matter which direction a tool 410 is tilted, the direction of the target object 400 (detection surface) is maintained to face the sensor mounted above the target object 400 at all times. As a result, the sensor is able to correctly recognize the target object 400 so as to successfully obtain relevant information of the target object 400.

Through the above example, it is possible to improve the unrecognized range in the tool usage posture, ensure free working posture of the worker, and realize non-contact three-dimensional coordinate measurement by simply mounting one target object.

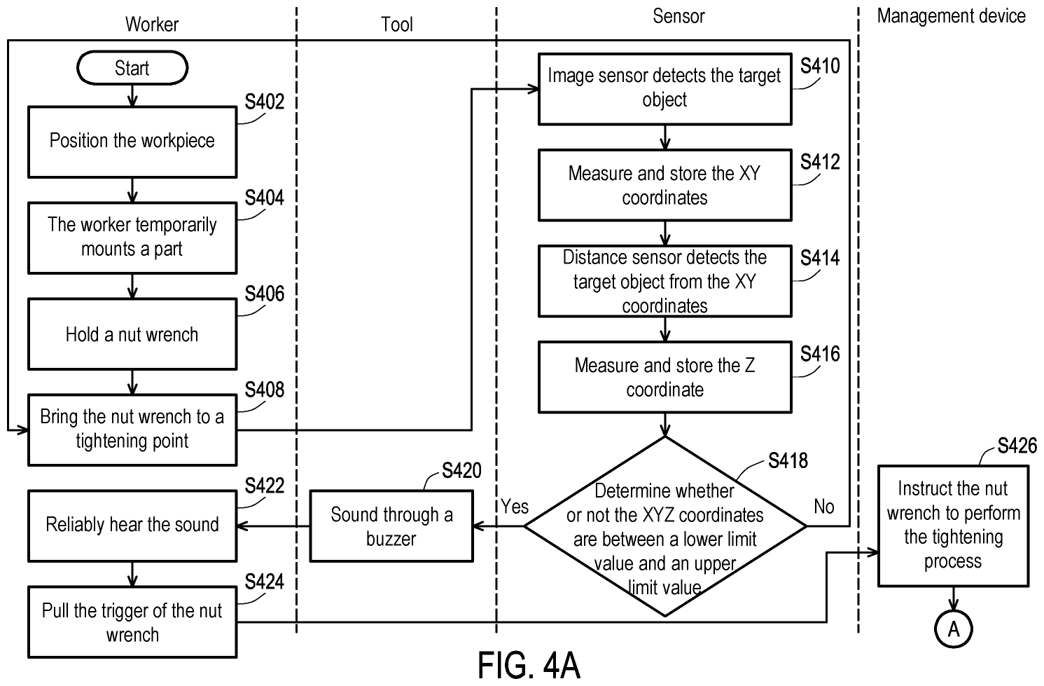

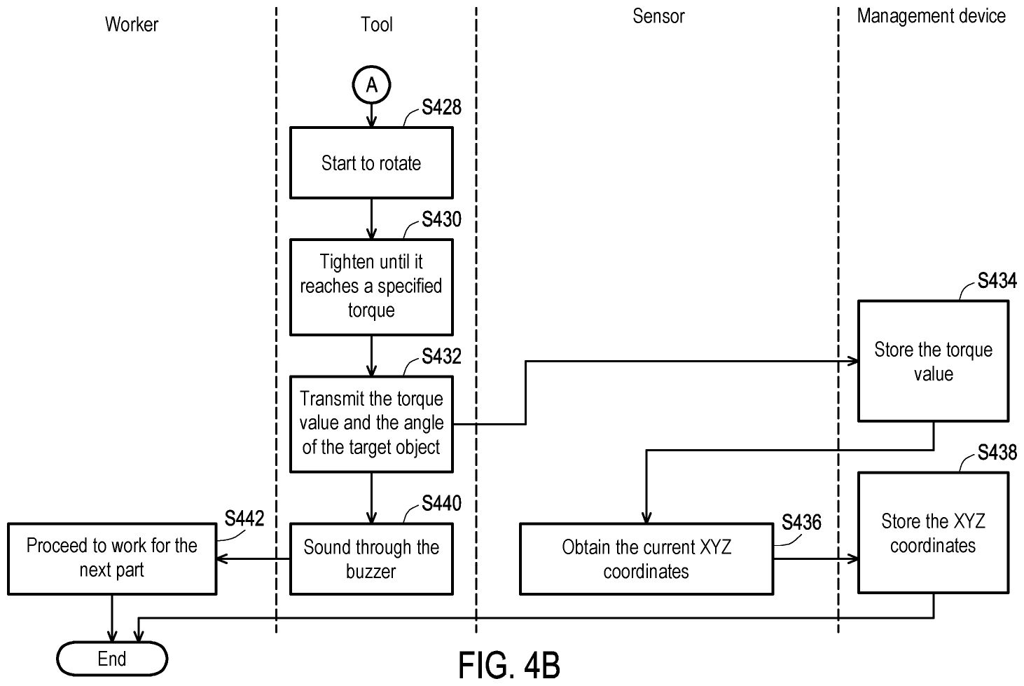

FIGS. 4A and 4B show a step flow chart of a work management method according to an embodiment of the disclosure. Please refer to FIG. 1, FIG. 4A and FIG. 4B at the same time. The work management method of this embodiment is applicable to the work management system 100 of FIG. 1. For ease of understanding, the personnel or components performing the steps are marked above each step, including the worker, tool, sensor, and management device. The work management method according to the embodiment of the disclosure will be described below in conjunction with various components in the work management system 100.

First, in step S402 of FIG. 4A, the worker positions the workpiece. In step S404, the worker temporarily mounts a part for work. In step S406, the worker holds a nut wrench (tool 200), and in step S408, the worker brings the nut wrench to a tightening point.

Next, in step S410, the image sensor included in the sensor 120 detects the target object 110, and the sensor 120 measures and stores the XY coordinates of the target object 110 in step S412. In step S414, the distance sensor included in the sensor 120 detects the target object 110 from the measured XY coordinates, and the sensor 120 measures and stores the Z coordinate of the target object 110 in step S416. In step S418, the sensor 120 determines whether or not the XYZ coordinates of the target object 110 are between a lower limit value and an upper limit value so as to determine whether or not the position of the target object 110 designed on the nut wrench is appropriate.

When the XYZ coordinates of the target object 110 are not between the lower limit value and the upper limit value, it means that the position of the target object 110 is inappropriate, so the process returns to step S408 and the nut wrench is repositioned.

When the XYZ coordinates of the target object 110 are between the lower limit value and the upper limit value, it means that the position of the target object 110 is appropriate. Thus, in S420, the nut wrench (tool 200) sounds through a buzzer.

Next, in step S422, the worker reliably hears the sound produced by the nut wrench, and then in step S424, the worker pulls the trigger of the nut wrench.

Once the trigger of the nut wrench is pulled, the management device 130 instructs the nut wrench to perform the tightening process in step S426, and proceeds to step S428 of FIG. 4B via a node A. In step S428, the nut wrench (tool 200) starts to rotate to tighten the nut until it reaches a specified torque (step S430).

Next, in step S432, the transmission unit 210 arranged on the nut wrench (tool 200) transmits the torque value and the angle of the target object to the management device 130. In step S434, the management device 130 stores the torque value.

Furthermore, in step S436, the sensor 120 obtains the current XYZ coordinates of the target object 110, whereby in step S438, the management device 130 stores the XYZ coordinates.

On the other hand, after the transmission unit 210 on the nut wrench (tool 200) transmits the torque value and the angle of the target object to the management device 130, in step S440, the nut wrench (tool 200) will sound through the buzzer, whereby in step S442, the worker proceeds to work for the next part.

In summary, in the work management system of the disclosure, a movable target object may be arranged on the tool, such that no matter how the direction of the tool changes, the target object is able to maintain the direction of the target object to face the sensor arranged in the facility (in the factory or on the equipment) at all times through its own movement or rotation. This allows the tool to change direction freely as the work progresses, which not only improves work efficiency but also contributes to energy efficiency. Moreover, unlike the situation where GPS is used for coordinate measurement, the disclosure can also avoid the decrease in accuracy caused by the presence of obstacles and communication carrier failures.

Finally, it should be noted that the above embodiments are only used to illustrate the technical solution of the disclosure, but not limited thereto. Although the disclosure is described in detail with reference to the above-mentioned embodiments, those skilled in the art should understand that the technical solutions described in the above-mentioned embodiments can still be modified, and some or all of the technical features may be rearranged equivalently; such modifications or replacements do not depart from the scope of the technical solutions described by the embodiments of the disclosure.

What is claimed is:

1. A work management system for managing an operating status of a tool of a worker, the work management system comprising:
a target object arranged on the tool; and
a sensor capable of detecting the target object,
wherein the target object is movable such that it faces the sensor.

2. The work management system according to claim 1, further comprising:
a management device for managing the operating status of the tool,
wherein the tool is provided with a transmission unit, and the transmission unit transmits operation information of the tool of the worker and orientation information of the target object when the tool is operated to the management device.

3. The work management system according to claim 1,
wherein the target object is rotatably arranged along an axial line extending horizontally relative to the tool, and a movable counterweight is provided such that the target object faces the sensor by gravity.

4. The work management system according to claim 2,
wherein the target object is rotatably arranged along an axial line extending horizontally relative to the tool, and a movable counterweight is provided such that the target object faces the sensor by gravity.

5. The work management system according to claim 1,
wherein the target object is provided on an upper surface of a liquid level, so as to be detectable by the sensor facing downward.

6. The work management system according to claim 2,
wherein the target object is provided on an upper surface of a liquid level, so as to be detectable by the sensor facing downward.
